(19) United States
(12) Patent Application Publication
(10) Pub. No.: US 2014/0108262 A1
(43) Pub. Date: Apr. 17, 2014

(54) Privacy Preserving E-Payment Architecture, Systems, and Methods

(71) Applicants: LABORATOIRE GREYC, CAEN Cedex 4 (FR); BULL S.A.S, Les Clayes Sous Bois (FR)

(72) Inventors: Aude PLATEAUX, BEUZEVILLE (FR); Vincent COQUET, CROISSY SUR SEINE (FR); Sylvain VERNOIS, MATHIEU (FR); Patrick LACHARME, CAEN (FR); Christophe ROSENBERGER, SAINT LAURENT DE CONDEL (FR)

(73) Assignees: LABORATOIRE GREYC, Caen Cedex 4 (FR); BULL S.A.S., Les Clayes Sous Bois (FR)

(21) Appl. No.: 14/052,493

(22) Filed: Oct. 11, 2013

Related U.S. Application Data
(60) Provisional application No. 61/712,616, filed on Oct. 11, 2012.

(51) Int. Cl. G06Q 20/38; G06Q 20/40

(52) U.S. Cl. CPC G06Q 20/3829; G06Q 20/40
USPC 705/71

(57) ABSTRACT

A method for providing privacy in online transactions. The method can include receiving, at a service provider system, a purchase request from a client, the purchase request including banking information, and the banking information being encrypted with a third party public key such that the service provider system cannot decrypt the encrypted banking information. The encrypted banking information can be transmitted to a bank system, such that the banking information cannot be used to identify the identity of the client. The method can also include receiving an authorization message if the client's purchase request is authorized.

This application claims the benefit of U.S. Provisional Application No. 61/712,616 filed Oct. 11, 2012, the disclosure of which is hereby incorporated by reference.

### FIELD OF THE INVENTION

Embodiments relate generally to online electronic payments (“e-payments”), including mobile payments (“m-payments”), and, more particularly, to systems and methods providing privacy protection to parties engaging in e-payment transactions for service and/or goods.

Some Embodiments relate generally to online electronic payments and, more particularly, to systems and methods providing online electronic payments for service and/or goods from a network device including, for example, an Internet terminal device, an Internet browser on a personal computer, an Internet browser on a TV, a mobile phone, and/or a tablet, such as an Apple iPad.

Some embodiments also relate to privacy of individuals and of e-payment SP (Service Providers).

Some embodiments also relate to Privacy of individuals and of m-payment SP.

### BACKGROUND OF THE INVENTION

3D-Secure protocol is a two-factor authentication system for e-payments originally developed by VISA Inc. Although the Secure Electronic Transaction (“SET”) protocol was in some respects more respectful of privacy than 3D-Secure, the 3D-Secure protocol is widely used on the web. Other financial organizations have developed their own implementations of VISA's 3D-Secure protocol, such as MasterCard's SecureCode, American Express's SafeKey, and JCB International's J/Secure.

In order to use the 3D-Secure protocol, a dedicated module, or Merchant PlugIn (“MPI”), is implemented into a Service Provider's (“SP's”) website. In addition, a dedicated server, or Directory, is made available to implement the 3D-Secure protocol.

FIG. 1 is an illustration of a 3D-Secure online e-payment architecture system studied by the inventors. The 3D-Secure protocol is composed of steps (labeled A-I in FIG. 1) which are exchanges between five actors: a client, a client bank, a merchant (or service provider (“SP”)), a SP bank, and a trusted third party.

At step A the client sends to the SP his purchase intention. The client provides banking information directly to the SP, such as: Personal Account Number (“PAN”) (e.g., the embossed card number), expiration date, and Card Verification Value (“CVV2”) (e.g., the visual cryptogram at the back of the card).

At step B, the MPI queries the Directory server with a Verify Enrolment Request (“VEReq”) message.

At step C the Directory server checks the SP's identity and the card number. The Directory server identifies the Access Control Server (“ACS”) managing the card and transfers the VEReq message to the ACS. The PAN allows the Directory server to identify the ACS.

At step D, the ACS checks if the client's card is enrolled in the 3D-Secure program and sends the cardholder authentication uniform resource locator (“URL”) to the MPI through the Verify Enrollment Result (“VERes”) message.

At step E, MPI sends the Payer Authentication Request (“PAReq”) message to the cardholder authentication URL. This message contains the details of the authorized purchase and requests the ACS to authenticate the cardholder. The authentication protocol depends on the cardholder's bank.

At step F, the client provides the necessary information for authentication to the bank.

At step G, the ACS sends to the MPI a confirmation of the client's authentication through a Payer Authentication Response (“PARes”) message.

At step H, the MPI records the PARes message as confirmation of the client's authentication by the ACS.

At step I, the SP authenticates to the SP bank which checks the nature of the transaction from the client's bank and confirms the payment authorization from the SP.

The SP then gets his payment and the client's bank stores payment information to ensure non-repudiation of the transaction.

Although not shown, additional steps are performed under the 3D-Secure protocol and therefore systems implementing the complete protocol perform more than the nine steps (A-I) described above.

It will be appreciated that services such as 3D-Secure described above have flaws which affect the client's privacy. While banks have corrected the flaw of using trivial client secrets as a basis for authentication (e.g. date of birth), by instead using other means such as, for example, a one-time password sent to a user's mobile phone, many flaws remain. For example, when the client moves to payment step, the client enters sensitive banking data (e.g., card number, expiration date, visual cryptogram). Although this information is for the SP bank, it directly passes through the SP. Consequently, the 3D-secure protocol may not assure adequate privacy protection. For example, transaction and payment data may be exchanged in clear text between the actors (even if it may be enciphered during it transportation on the Internet) which presents at least the following privacy concerns:
The SP can easily store the client's banking data;
The client's bank knows the SP's identity;
The SP knows the client's bank;
The SP bank knows the client; and
The client/SP banks may be able to access order information.

More precisely, in a first step (step A), the client sends his/her banking information to the SP bank. However, this information can identify the client. Moreover, the client's bank knows the SP identity and the SP bank knows the client's identity. Then, even if the client's authentication is realized by the client's bank, this authentication is also realized by the Directory server (step C). Similarly, the SP authentication is not realized by the client or by a client's trusted part (step C. and I.). In addition, the order information is contained in the PAReq message sent to ACS (step E.), these data are consequently not confidential. Finally, the client lacks total control over these data which passes through many entities. In addition, in terms of privacy, the sensitivity of exchanged information is not sufficiently taken into account.

Electronic cheque schemes are often difficult to use for the average user. Indeed, these systems lead to the use of client's certificate and an electronic checkbook card. Many computations and storages by the client's bank are also required. Finally, these schemes do not generally take into account privacy protection.

For e-payment transactions there may be a need to preserve the privacy of clients and SPs engaging in online e-payment transactions.

### BRIEF DESCRIPTION OF THE DRAWINGS

Embodiments will hereinafter be described in detail below with reference to the accompanying drawings, wherein like reference numerals represent like elements.

FIG. 1 illustrates a 3D-Secure online e-payment architecture system studied by the inventors;

FIG. 2 illustrates an exemplary embodiment of an online e-payment architecture preserving privacy system;

FIG. 3 is a block diagram illustrating an online e-payment architecture preserving privacy system;

FIG. 4 is a flowchart showing an exemplary method for processing online electronic payments while preserving privacy;

FIG. 5 is a block diagram of an exemplary embodiment of an online e-payment architecture preserving privacy system;

FIG. 6 illustrates another exemplary embodiment of an online privacy preserving e-payment architecture system; and

FIG. 7 is a flowchart showing an exemplary method for processing online electronic payments while preserving privacy.

### DETAILED DESCRIPTION

Embodiments relate generally to online electronic payments and, more particularly, to systems and methods providing online electronic payments for service and/or goods from a network device including, for example, an Internet terminal device, an Internet browser on a personal computer, an Internet browser on a TV, a mobile phone, and/or a tablet, such as an Apple iPad.

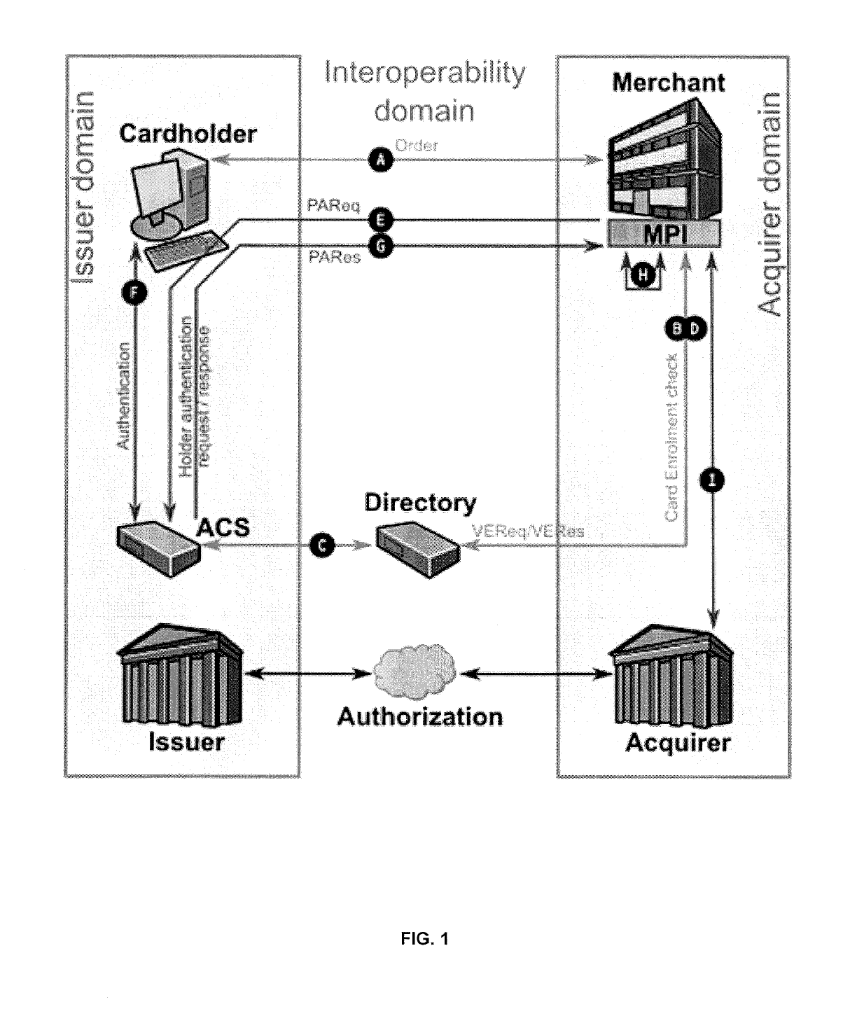

FIG. 1 illustrates a 3D-Secure online e-payment architecture system studied by the inventors, as described above.

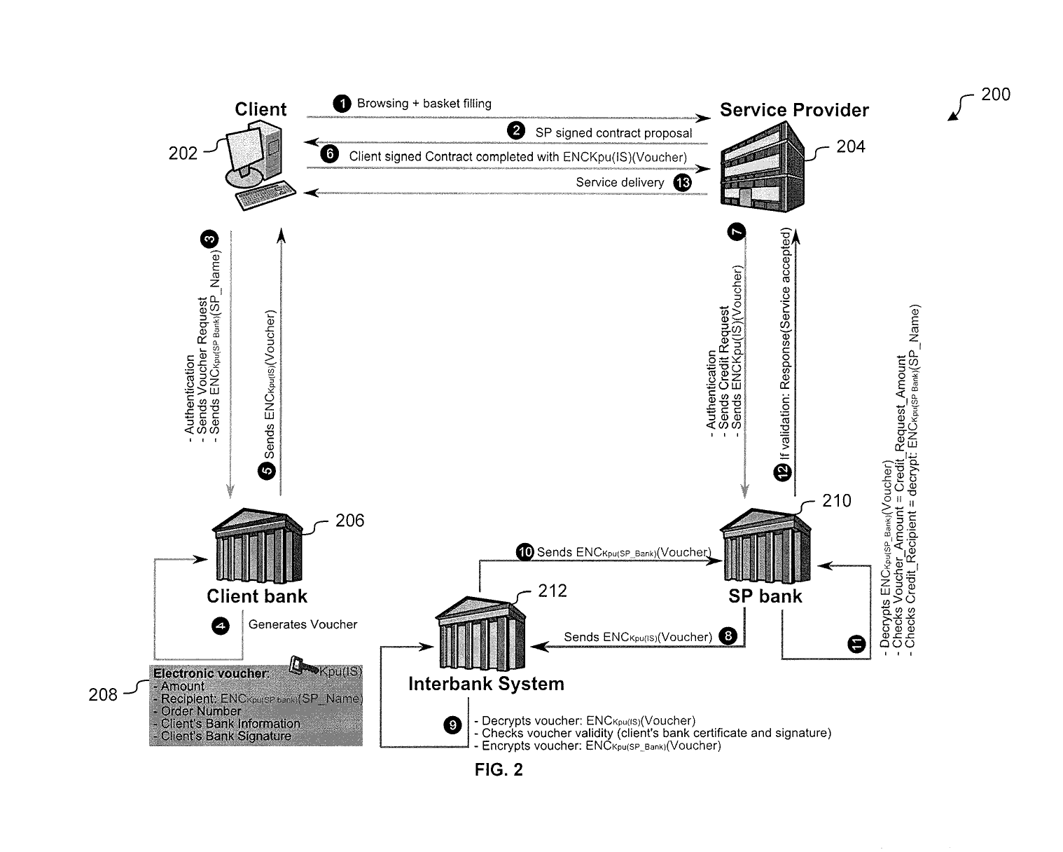

FIG. 2 illustrates an exemplary embodiment of an online e-payment architecture preserving privacy system 200. In this infrastructure, five main actors are present:
The client C (202);
The service provider SP (204);
The client payment provider PPC (206), that is to say the debit account bank;
The SP payment provider PPSP (210), that is to say the credit account bank;
An interbank trusted third party (for instance: a payment scheme), also named interbank system IS (212) whose goal is detailed later.

The online e-payment architecture respecting the privacy of the users and SP is based on an electronic bank voucher, issued and signed by the client's bank and transmitted to the SP bank, encrypted by the public key of the IS or Intermediate Certification Authority used by the e-payment transaction.

This voucher is relayed by the client and the SP, so that neither the SP knows the client's bank, nor the client knows the SP bank.

The IS or Intermediate Certification Authority used all over the e-payment transaction is used by the SP bank to decrypts and re-encrypts the voucher, using respectively its private key and the public key of the SP bank.

The recipient's name (SP name) is not known by the IS or Intermediate Certification Authority used by the e-payment transaction as it is encrypted with a randomly generated symmetric key—one per transaction—itself encrypted under the public key of the SP bank.

Each client and SP bank must have signed a contract with the same IS. Each one must have generated a key pair which public key is certified by the IS. This latter publishes these certificates. Client and SP banks may contract with more than one IS.

Every PPC and PPSP public key certificate can contain the following:
The PPC or PPSP bank name: BankC or BankSP respectively;
The PPC or PPSP bank public key: Kpublic(PPC) or Kpublic(PPSP) respectively;
The public key hash algorithm: SHA-1 for instance;
The signature algorithm: RSA for instance;
The universal identifier of the IS Certification Authority.

Similarly, each Client and SP must have signed a contract with their bank for the same IS. Each one must have generated or received a key pair which public key is certified by the corresponding IS or by an Intermediate Certification Authority of the IS. Each IS and Intermediate Certification Authority publishes the certificates it signed. Client and SP may contract with more than one banks, for one or more IS.

Every Client or SP public key certificate can contain the following:
The Client or SP name: Client1 or SP1, respectively;
The Client or SP public key: Kpublic(Client) or Kpublic(SP), respectively;
The public key hash algorithm: SHA-1 for instance;
The signature algorithm: RSA for instance;
The universal identifier of the IS Certification Authority or Intermediate Certification Authority.

In order to make easier the reading and interpretation of these certificates, they should be standardized (for instance: X.509).

However, some embodiments allow Clients and SP not to reveal the identity of their bank. Thus, in order to add privacy for Clients and SP, the generation of their certificate should not be by related to their bank, as Intermediate Certification Authority under the authority of the IS Certification Authority. A trusted party different from their bank is preferable. It's why the IS Intermediate Certification Authority should be an independent third trusted party, different from the Client, respectively, SP, bank.

The online payment phase can respect the customer's privacy and restrict the disclosure of personal information. Moreover, it can provide a better security for the transaction between the Client and the SP. The following describes this solution.

With regard to the payment phase, in the case where authentication and/or registration with the SP are required, it is assumed that it is properly conducted, without intrusion into Client's privacy. Indeed, a priority is to ensure SP to be paid and therefore have a secure payment protocol. SP has not to know other client's personal information.

This proposal is based on the generation of two documents:
A commercial contract signed between the SP and the Client;
An electronic bank voucher issued by the bank of the Client.

The IS can play a role of a trusted third party. It can enable communication between banks without revealing information about:
The end-to-end actors (point specific to this online payment architectures):
   The SP identity is not known from the Client's bank;
   The SP bank doesn't know the Client's identity;
   The Client's identity is not known from the SP bank;
   The Client's bank doesn't know the SP identity;
The nature of the contract signed by the Client (point specific to this online payment architectures), as a consequence of the previous points concerning the confidentiality of:
   The SP identity against the Client's bank;
   The Client's identity against the SP bank;
The details of the contract sealed between the SP and the Client (point common with other online payment architectures).

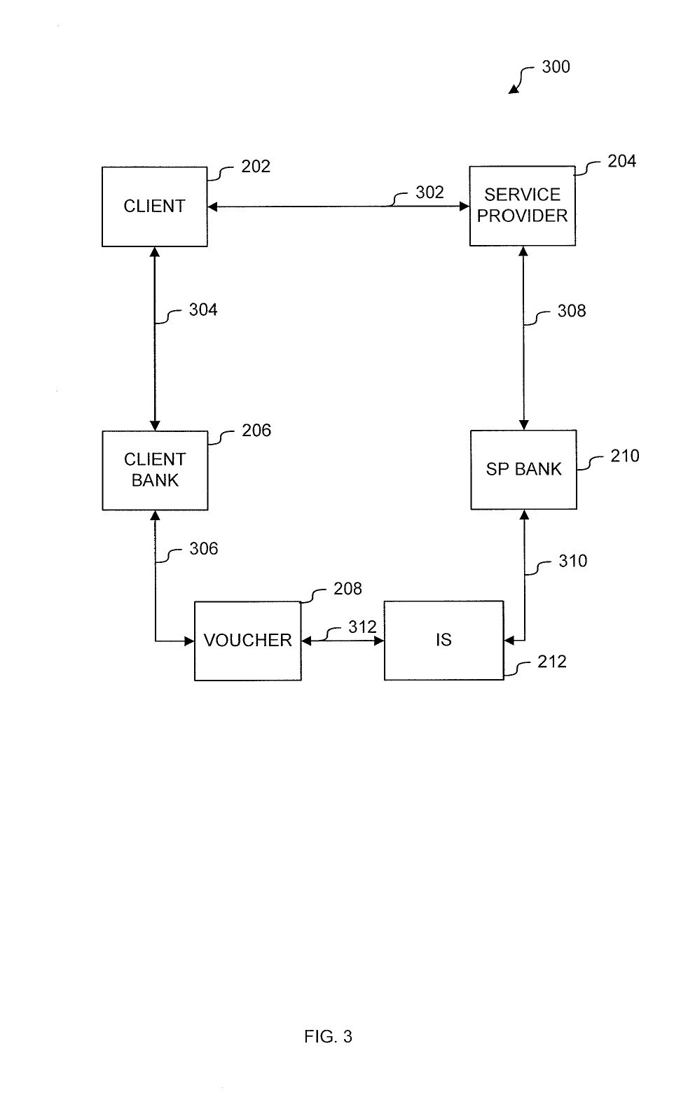

FIG. 3 is a block diagram illustrating an online e-payment architecture preserving privacy system 300. The system 300 can include a client 202, a service provider 204, a client bank 206 that can generate a voucher 208, an IS 212, and an SP bank 210, each corresponding to the similarly numbered items of FIG. 2 and described above.

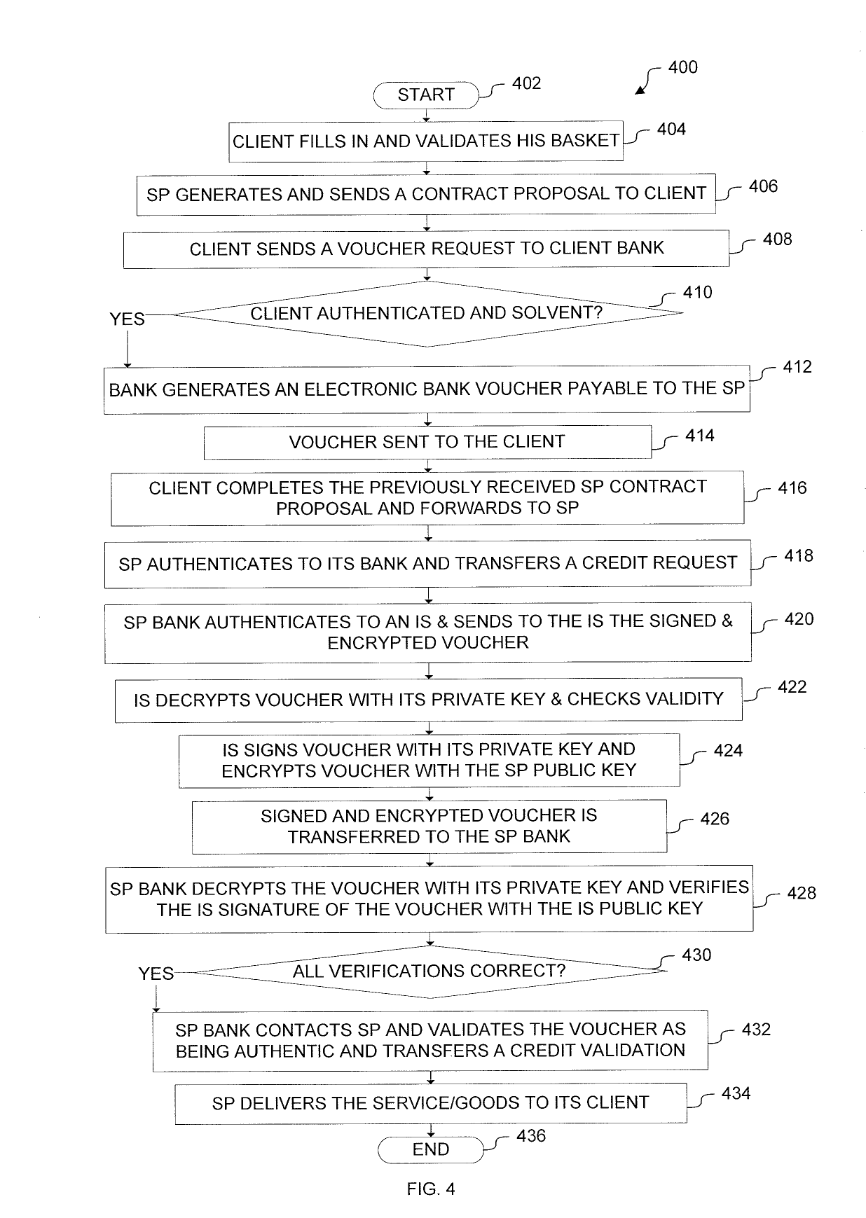

FIG. 4 is a flowchart showing an exemplary method 400 for processing online electronic payments while preserving privacy. Processing begins at 402 and continues to 404.

At 404, the client fills in and validates his basket. Processing continues to 406

At 406, the SP generates and signs a contract proposal containing:
The detailed shopping list of the transaction: item quantity, unit price, total price;
The total amount of purchases;
The currency;
A proposal number generated by the SP;
The SP public key certificate corresponding to the private key of signature and issued by the IS or an Intermediate Certification Authority of the IS;
The cryptogram of a randomly generated symmetric key—one per transaction-encrypted under the SP bank public key;
The name of the SP encrypted by the above symmetric key;
The SP signature of the contract.

To respect the client's privacy during the transfer of data to different banks, the proposal number has not to contain SP information, as the business number or name.

The contract is signed by the SP with the respect of legislation. The contract does not bind the customer to pay. It urges SP on to provide all items at indicated price to the customer if this latter pays.

This contract is sent to the client. Processing continues to 408.

At 408, the client connects to his bank, using, for example, a macro of its Internet browser for example, authenticating with the method and tools of its bank. For example, this macro can establish an HTTPS connection and send a voucher request to the client bank.

The voucher request contains the following necessary information for the client's bank; it is extracted from the contract proposal and of client's information:
The whole amount;
The currency;
The cryptogram of the symmetric key encrypted under the SP bank public key;
The name of the SP encrypted by the above symmetric key;
The proposal number generated by the SP;
The client's signature of the voucher request;
The client's public key certificate corresponding to the private key of signature and issued by the IS or an Intermediate Certification Authority of the IS.

The client adds the recipient's name for the future credit, that is to say the SP. However, the client's bank has not to know the SP identity. The name of the SP is encrypted.

The encrypted SP name allows the client's bank to insert the order of his future electronic bank voucher. Processing continues to 410.

At 410, if the client authentication is successful and the client is solvent, the bank positively responds to the client's request and processing continues to 412.

At 412, the bank generates an electronic bank voucher payable to the SP. This electronic voucher includes:
The total amount of the purchase;
The currency;
The name of the SP, encrypted by the SP bank public key (information extracted from the SP public key certificate);
The information of the client's bank;
The client's bank signature of the voucher;
The client's bank public key certificate corresponding to the private key of signature and issued by the IS or an Intermediate Certification Authority of the IS.

The client's bank encrypts the voucher with the public key of the IS or Intermediate Certification Authority pointed out by the client's public key certificate. Processing continues to 414.

At 414, the voucher is sent to the client. Processing continues to 416.

At 416, the client, for example via the client's browser macro, completes the previously received SP contract proposal with the following:
the signed and encrypted voucher;
its client's public key certificate, signed by the same IS or Intermediate Certification Authority as the one pointed out in the SP public key certificate;
a minimum of personal information, like majority—not age.

The client signs the whole before to forward it to the SP. The voucher being encrypted, the SP cannot know client's bank information. Processing continues to 418.

At 418, the SP authenticates to its bank and transfers to it a credit request composed of the following:
The whole amount;
The currency;
The proposal number generated by the SP;
The signed and encrypted electronic bank voucher.
The SP signature of the credit request;
The SP public key certificate corresponding to the private key of signature and issued by the IS or an Intermediate Certification Authority of the IS.

The SP bank is able to identify the SP. Indeed, the name of the SP, encrypted by the SP bank public key is included in the SP public key certificate. Processing continues to 420.

At 420, the SP bank authenticates to the IS or Intermediate Certification Authority of the IS pointed out in the SP public key certificate and transfers to it the signed and encrypted electronic bank voucher. Processing continues to 422.

At 422, the IS decrypts electronic voucher with its private key. It checks the validity of this voucher; therefore it verifies:

The certificate and identity of the client's bank;

The signature of the voucher.

Processing continues to 424.

At 424, the IS again signs the entire voucher, as defined at 412, using its private key; it encrypts it with the SP bank public key.

It will be appreciated that one or more of the operations may be done in an HSM (Hardware Security Module).

Processing continues to 426.

At 426, the signed and encrypted voucher is transferred to the SP bank. Processing continues to 428.

At 428, the SP bank decrypts the voucher with its private key and verifies the IS signature of the voucher with the IS public key.

It can be checked that the voucher amount and currency are similar to those provided by the SP in the credit request. Then, the bank can decrypt the recipient's name using its private key corresponding to the IS certifying the public key of the SP in the credit request. Processing continues to 430.

At 430, if all verifications are correct, processing continues to 432.

At 432, the SP bank contacts SP and validates the voucher as being authentic.

Then, the SP bank transfers a credit validation composed of the following:
The whole amount;
The currency;
The proposal number generated by the SP;
The signed and encrypted electronic bank voucher.
The signature of the SP bank;
The SP bank public key certificate corresponding to the private key of signature and issued by the IS or an Intermediate Certification Authority of the IS.

Processing continues to 434.

At 434, confident that the voucher is authentic, the SP delivers the service and/or goods to its client. The SP bank also joins the client's bank, located through the client's bank public key certificate contained in the electronic voucher. Processing continues to 436, where processing ends.

The debit-credit process between banks completes this payment architecture in respecting the client's privacy:
The SP bank encrypts the electronic voucher with the client's bank public key;
The SP bank sends this encrypted voucher;
The client's bank decrypts the voucher with its private key and checks it;
Both banks respectively carry the debit and credit of the account of the client and SP.

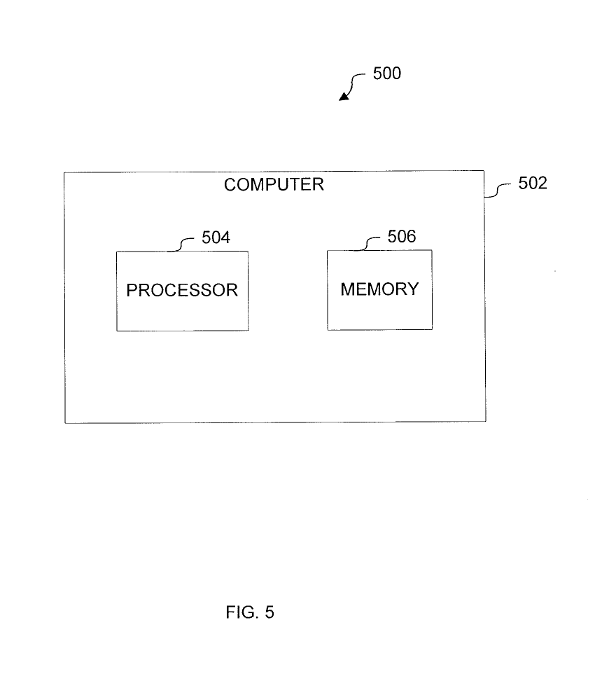

FIG. 5 is a block diagram of an exemplary embodiment of an online e-payment architecture preserving privacy system. System 500 can include a computer 502 that can include a processor 504 and a memory 506.

In operation, the processor 504 will execute instructions stored on the memory 506 that cause the computer 502 to perform one or more steps of the process shown in FIG. 4.

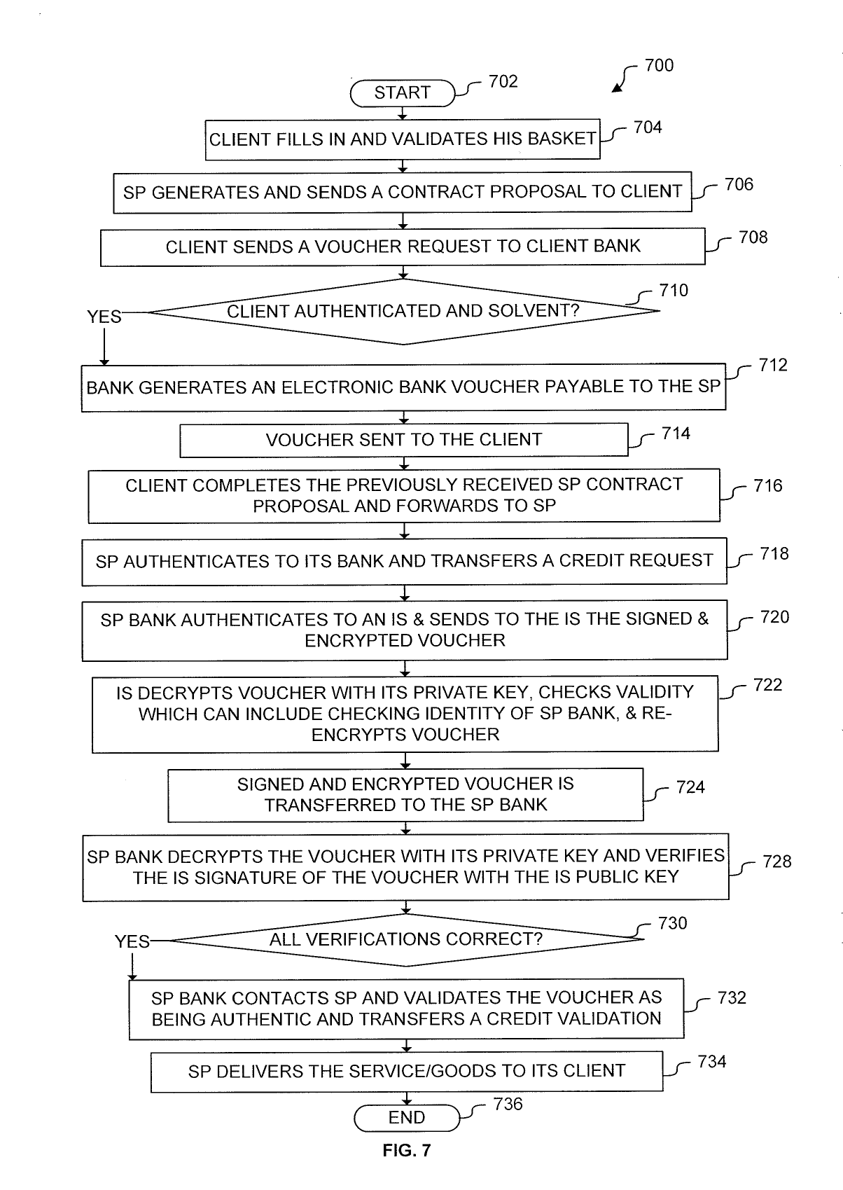

In some embodiments, the processor 504 will execute instructions stored on the memory 506 that cause the computer 502 to perform one or more steps of the process shown in FIG. 7.

It will be appreciated that more than one computer 502 may be used to perform the steps shown in FIG. 4. For example, more than one 502 can be connected to each other via a network and each performing one or more steps of the process shown in FIG. 4.

It will also be appreciated that more than one computer 502 may be used to perform one or more steps of the process shown in FIG. 7. For example, more than one computer 502 can be connected to each other (e.g., via a network) and each performing one or more steps of the process shown in FIG. 7.

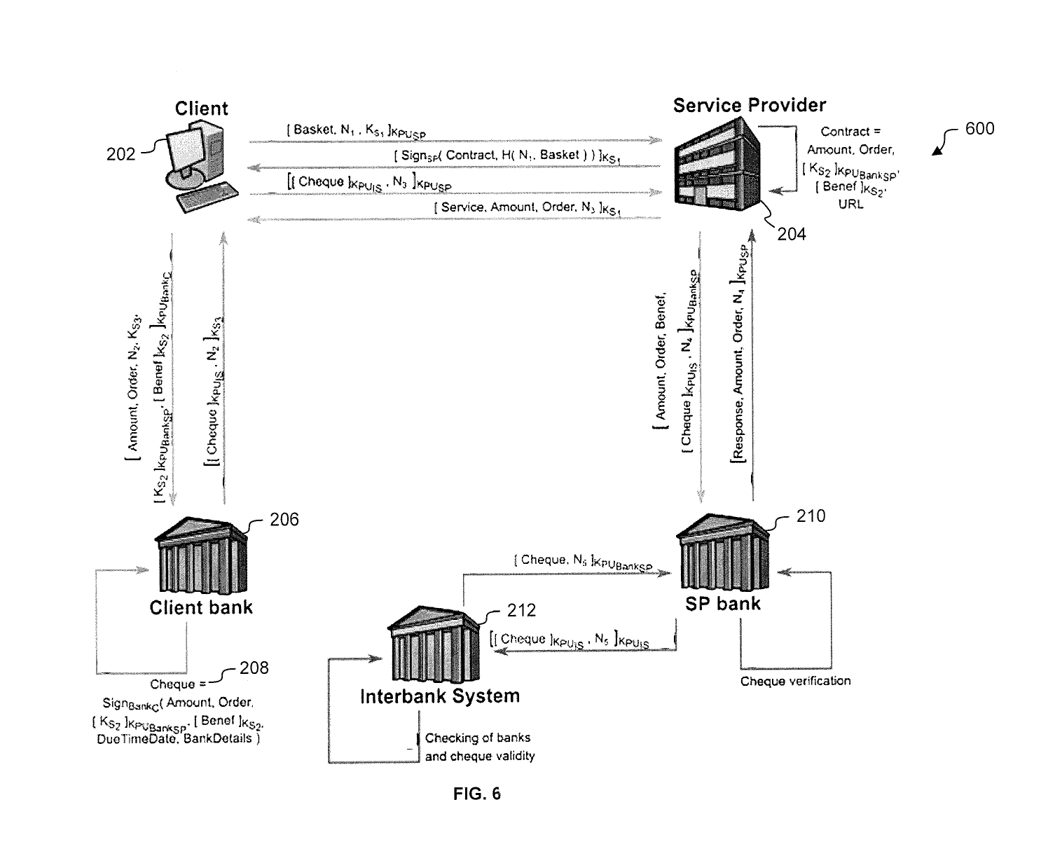

FIG. 6 illustrates another exemplary embodiment of an online privacy preserving e-payment architecture system 600. In such embodiments, system 600 can combine advantages of electronic check systems and easy-to-use online payment systems. System 600 can include:
client 202;
service provider 204 (or SP);
client bank 206 (e.g., the debit account bank);
SP bank 210 (e.g., the credit account bank); and
interbank system 212 (or “IS”) (or “interbank trusted third party”) (e.g., an Intermediate Certification Authority (“CA”) or a trusted third party connected to a CA).

In operation, client 202 can transmit data to/from client bank 206 and SP 204; SP 204 can transmit data to/from SP bank 210; and IS 212 can transmit data to/from both client bank 206 and SP bank 210, according to the methods described in FIGS. 4 and/or 8.

Embodiments of online privacy preserving e-payment architecture system 600 can be operated by generating and using two documents:
A contract between SP 204 and client 202; and
A checque 208 (or “voucher,” or “electronic voucher,” or “electronic bank voucher”) which is an electronic bank document.

In some embodiments, electronic bank voucher 208 can be issued and signed by client bank 206 and transmitted to SP bank 210, encrypted by a public key published by IS 212. Voucher 208 can be relayed between client 202 and SP 204, such that SP 204 does not know the identity of client bank 206 (and vice versa), and client 202 does not know the identity of SP bank 204 (and vice versa). In some embodiments, IS 212 can decrypt and re-encrypt voucher 208 using its own (IS 212's) private and public keys, respectively.

In some embodiments, client 202 and SP 204 each sign contracts with their respective bank to permit the use of a trusted third party such as IS 212. In such embodiments, client 202 and SP 204 each can generate or receive a public and private key certificate pair, and the public key certificates can be certified and published by IS 212.

It will be appreciated that, although not shown in FIG. 2, client 202 and SP 204 can each contract with multiple banks for the use of multiple interbank systems (e.g., trusted third parties or certificate authorities) and can complete transactions with each other using any of their respective banks which share a common interbank system.

In embodiments, the public key certificates for client 202 and SP 204 can comprise:

A name of client 202 and SP 204, respectively;

A public key for client 202 and SP 204, respectively;

A public key hash algorithm (e.g., Secure Hash Algorithm 1 (“SHA-1”));

A signature algorithm (e.g., RSA); and

A universal identifier of IS 212.

Some embodiments include an electronic bank voucher, issued and signed by the client's bank and transmitted to the SP bank, encrypted by the public key of the IS or Intermediate Certification Authority used all over the e-payment transaction.

The voucher can be relayed by the client and the SP, so that neither the SP knows the client's bank, nor the client knows the SP bank.

The IS or Intermediate Certification Authority used all over the e-payment transaction is used by the SP bank to decrypt and re-encrypt the voucher, using respectively its private key and the public key of the SP bank.

In some embodiments, the recipient's name (SP name or beneficiary name) is only known by the IS or Intermediate Certification Authority used all over the e-payment transaction as it is encrypted by the SP with a randomly generated symmetric key—one per transaction—itself encrypted by the SP under the public key provided by the client to the SP through the public key certificate of the IS or Intermediate Certification Authority.

The recipient's name can be decrypted and verified by the IS or Intermediate Certification Authority before transmitting the voucher (e.g., over SSL) to the SP bank.

Each bank can generate a key pair, where the public key is certified by the IS. The IS can publish these certificates which contain the following: its name; its public key; the hash function algorithm; the signature algorithm and the name of certification authority.

Similarly, the SP has a key pair, where the public key is certified by the trusted third party contractualized with, for instance the interbank system or IS. This certificate is composed by the following data: its name; its public key; the hash function algorithm; the signature algorithm; the name of certification authority and the parameters describing the payment scheme recognizing the SP and allowing to secure the future payment (e.g., American Express, VISA, MasterCard, etc.).

In addition, some embodiments allow the SP not to reveal the identity of its bank. Thus, in order to add privacy for the SP, the generation of the SP certificate by a trusted party different from the SP bank is preferable. For instance, the interbank system, IS, or another intermediate trusted party could play this role.

In some embodiments, standard certificate formats can be used, such as X.509.

Embodiments of online privacy preserving e-payment architecture system 600 can respect the privacy of client 202 and restrict the disclosure of personal information. Moreover, embodiments can provide enhanced security for transactions between client 202 and SP 204.

In embodiments where authentication and/or registration with SP 204 is required to begin a payment phase (or “check out”) (e.g., requiring client 202 to create an account with SP 204 prior to making a payment), such registration can be conducted without intrusion into the privacy of client 202. In embodiments, SP 204 can accept payment using the public key certificate of IS 212 without knowing any other personal information of client 202.

The following notations are used herein to describe embodiments of an online privacy preserving e-payment architecture system:

Sign_{X}(m)—Signature of message m by actor/system X;

[m]K_{PU}_{_{X}}—Encryption of message m by the public key K_{PU} of actor/system X;

[m]K_{S}_{_{X}}—Encryption of message m by the session key K_{S} of actor/system X;

Nᵢ—Random number i used to guarantee freshness of messages; and

H (m)—Hashing of message m.

In embodiments, IS 212 is a trusted third party that can enable communication between banks without revealing information about the other actors. For example:
The end-to-end actors are not revealed:
   SP bank 210 doesn't know the identity of client 202, and vice versa;
   Client bank 206 doesn't know the identity of SP 204, and vice versa;
The nature of the contract between client 202 and SP 204 is not revealed, as a consequence of the previous points concerning the confidentiality of:
   SP 204's identity against client bank 206;
   Client 202's identity against SP bank 210;
The existence of the contract between client 202 and SP 204 is not revealed (because, e.g., the identities of the actors are not revealed); and/or
The details of the contract sealed between client 202 and SP 204 are not revealed.

FIG. 7 is a flowchart showing an exemplary method 700 for processing online electronic payments while preserving privacy. Processing begins at 702 and continues to 704.

At 704, client 202 creates a basket and sends the basket to SP 204 with a random number, N₁, as well as a session key, K_{S}_{₁}. N₁ can be used to ensure the freshness of the message and K_{S}_{₁} can be used to encrypt data between client 202 and SP 204. In embodiments where client 202 has a certificate, the session key K_{S}_{₁} can be replaced by client 202's public key. The message can be encrypted using a public key of SP 204, K_{PU}_{_{SP}}.

Client→SP:[Basket,N₁,K_{S}_{₁}]K_{PU}_{_{SP}} (1)

Processing continues to 706.

At 706, SP 204 generates and signs a contract proposal. The proposal can contain:
A total amount, Amount, for the items/services being purchased;
A random order number, Order, generated by SP 204 (this number does not need to link to SP 204's identity);
A symmetric random key, K_{S}_{₂}, encrypted by a public key of IS 212, K_{PU}_{_{IS}} (client 202 can select which trusted third party to use as IS 212 by passing the selection to SP 204 at registration time or by including the selection in the message described by formula (1) above);
A beneficiary name, Benef, encrypted by symmetric random key K_{S2};
A return URL of SP 204 in order to return to the payment page; and
A detailed shopping list basket, such as quantity and/or unit price per item.

In embodiments where SP 204 has a certificate, the symmetric random key K_{S}_{₂} can be replaced by SP 204's public key.

The generated contract proposal can be defined as:

SP:Contract=Amount,Order,[K_{S}_{₂}]K_{PU}_{_{IS}},[Benef]K_{S}_{₂},K_{PU}_{_{IS}},URL (2)

To respect the client's privacy during the transfer of data to different banks, the proposal number is not required to contain information relating to the identity of SP 204, such as the business number or name.

To avoid non-repudiation and ensure authenticity of the contract, SP 204 signs the contract proposal. The contract is consequently signed by SP 204 in accordance with applicable laws. The contract does not bind the customer to pay. It urges SP on to provide all items at indicated price to the customer if this latter pays.

This contract is sent to the client with a hash of N₁ and the basket. The message is encrypted by SP 204 using the symmetric key provided by client 202, K_{S}_{₁}:

Client←SP:[Sign_{SP}(Contract,H(N₁,Basket))]K_{S}_{₁} (3)

Processing continues to 708.

At 708, client 202 connects to its bank, e.g. client bank 206, using, for example, a plugin of its Internet browser, authenticating with the method and tools of its bank. For example, the plugin can establish an HTTPS connection and send a voucher request to client bank 206. The authentication protocol can depend on the client's bank, but a strong authentication protocol is recommended.

The voucher request can contain the following information, some of which can be extracted from the contract proposal and/or the client's information:
The whole amount (e.g. the amount to be paid) (the currency to be used can also be included);
The random order number provided by SP 204, Order;
The encrypted symmetric key provided by SP 204, [K_{S}_{₂}]K_{PU}_{_{IS}};
The encrypted beneficiary name, [Benef]K_{S}_{₂};
A random number, N₂; and
A symmetric key, K_{S}_{₃}, to be used by client bank 206 to encrypt messages sent to client 202 (e.g., a public key for client 202 or a session key).

The client adds the recipient's name for the future credit (e.g. the name of SP 204). However, client bank 206 does not know the identity of SP 204 because the name of SP 204 is encrypted.

The random number N₂ can ensure the freshness of messages. In embodiments in which client 202 does not have a public key certificate to provide as symmetric key K_{S}_{₃}, a session key can be provided as symmetric key K_{S}_{₃}. Client bank 206 can use symmetric key K_{S}_{₃} to encrypt messages sent to client 202. To encrypt the beneficiary's name, a session key is favored in order to reduce the computation complexity.

The encrypted SP name allows client bank 206 to insert the order of a future electronic bank voucher 208.

$$Client -> {Bank}_{C} \text{:} \\ [ Amount , Order , [ {K}_{{S}_{2}} ] {K}_{{PU}_{IS}} , [ Benef ] {K}_{{S}_{2}} , {N}_{2} , {K}_{{S}_{3}} ] {K}_{{PU}_{{Bank}_{C}}} \qquad ( 4 )$$

Processing continues to 710.

At 710, if the client authentication is successful and the client is able to make the indicated purchase (e.g. is solvent and/or creditworthy), client bank 206 positively responds to client 202's request, and processing continues to 712.

At 712, client bank 206 generates electronic bank voucher 208 payable to [Benef]K_{S}_{₂} (the encrypted beneficiary's name). The electronic voucher 208 can include:

The total amount of the purchase (currency to be used can also be included);

The random order number provided by SP 204, Order;

The encrypted symmetric key provided by SP 204, [K_{S}_{₂}]K_{PU}_{_{IS}};

The encrypted beneficiary name, [Benef]K_{S}_{₂};

The public key certificate of IS 212 used to encrypt the symmetric key;

The information of client bank 206;

A signature of client bank 206, Sign_{Bank}_{_{C}}; and

The public key certificate of the key used to sign electronic bank voucher 208.

Client bank 206 signs with its private key and encrypts voucher 208 with the public key of IS 212. In some embodiments, the public key of IS 212 used to encrypt voucher 208 can be pointed out by the public key certificate of client 202. Thus, IS 212 could check the identity of client bank 206 and the validity of voucher 208.

Bank_{C}:Voucher=Sign_{Bank}_{_{C}}(Amount,Order,[K_{S}_{₂}]K_{PU}_{_{IS}},[Benef]K_{S}_{₂},DueTimeDate,BankDetails) (5)

Processing continues to 714.

At 714, voucher 208 is sent to client 202.

Client←Bank_{C}:[[Voucher]K_{PU}_{_{IS}},N₂]K_{S}_{₃} (6)

Processing continues to 716.

At 716, client 202 forwards voucher 208 to SP 204. N₂ and N₃ can be used to ensure the freshness of transactions. N₂ can also provide the identity of the request. The result being encrypted, SP 204 cannot know client's banking information.

Client→SP:[[Voucher]K_{PU}_{_{IS}},N₃]K_{PU}_{_{SP}} (7)

Processing continues to 718.

At 718, SP 204 obtains the encrypted voucher 208, [Voucher]K_{PU}_{_{IS}}, and N₃ using its (SP 204's) private key. SP 204 authenticates to SP bank 210 and provides its filtered contract, and the signed and encrypted electronic bank voucher 208. The filtered contract can contain:

The whole amount;

The currency;

The beneficiary's name; and

The random order number.

In embodiments, the authentication protocol used can depend on SP bank 210. However, a strong authentication is recommended.

$$SP -> {Bank}_{SP} \text{:} \\ [ Amount , Order , Benef , [ Voucher ] {K}_{{PU}_{IS}} , {N}_{4} ] {K}_{{PU}_{{Bank}_{SP}}} \qquad ( 8 )$$

SP bank 210 is able to identify SP 204. Indeed, the name of SP 204, encrypted by SP bank 210's public key is included in SP 204's public key certificate. Processing continues to 720.

At 720, in order to validate the banks identities and voucher 208, SP bank 210 authenticates to IS 212 (or Intermediate Certification Authority of IS 212 which can be pointed out in SP 204's public key certificate) and transfers to IS 212 the signed and encrypted electronic bank voucher 208. N₅ can be used for the freshness of the transaction:

$$BankSP -> IS \text{:} [ [ Voucher ] {K}_{{PU}_{IS}} , {N}_{5} ] {K}_{{PU}_{IS}} \qquad ( 9 )$$

In some embodiments, the interbank system selected to be used as IS 212 can be included in SP 204's public key certificate. In some embodiments, IS 212 can delegate operations to an Intermediate Certification Authority of IS 212.

Processing continues to 722.

At 722, IS 212 can decrypt the message received from SP bank 210 and can verify N₅. IS 212 can verify and decrypt electronic bank voucher 208 with its (IS 212's) private key and can check the identity of SP bank 210.

IS 212 can decrypt voucher 208 and check its validity by verifying, for example:

The certificate, identity, and/or signature of client bank 206; and/or

The signature of voucher 208.

IS 212 can decrypt the session key K_{S}_{₂} which is used to decrypt the beneficiary's name; thus IS 212 is able to make regulatory controls on behalf of client bank 206.

If the verifications are correct, IS 212 can re-encrypt voucher 208 containing the beneficiary's name in clear, with the public key of SP bank 210.

Processing continues to 724.

At 724, voucher 208 is transferred to SP bank 210. N₅ can be re-used to identify the request.

$${Bank}_{SP} ← IS \text{:} [ Voucher , {N}_{5} ] {K}_{{PU}_{{Bank}_{SP}}} \qquad ( 10 )$$

It will be appreciated that one or more of the operations may be done in a Hardware Security Module (HSM).

Processing continues to 728.

At 728, SP bank 210 decrypts voucher 208 with its (SP 210's) private key and verifies IS 212's signature of voucher 208 with the public key of IS 212.

In some embodiments, it can be checked that voucher 208 amount and currency are similar to those provided by SP 204 in the credit request. In such embodiments, the bank can compare the beneficiary's name of the filtered contract with the decrypted name of electronic voucher 208.

In some embodiments, SP bank 210's verification of client bank 206's signature can be optional (when, for example, IS 212 has already performed this verification). In such embodiments, SP bank 210 can directly use client bank 206's information. Processing continues to 730.

At 730, if all verifications are correct, processing continues to 732. Otherwise, if any verification fails, the transaction can be cancelled.

At 732, SP bank 210 contacts SP 204 and validates voucher 208 as being authentic which allows SP 204 to deliver good(s)/service(s) for client 202. The random numbers N₃ and N₄ can be used to identify the requests and to guarantee the freshness of transactions.

SP←Bank_{SP}:[Response,Amount,Order,N₄]K_{PU}_{_{SP}} (11)

Client←SP:[Service,Amount,Order,N₃]K_{S}_{₁} (12)

Processing continues to 734.

At 734, SP bank 210 also joins client bank 206, located through the client bank 206's public key certificate contained in electronic voucher 208.

The debit-credit process between banks completes the payment architecture in respecting the client's privacy:
SP bank 210 encrypts electronic voucher 208 within its payment request with the client bank 206's public key;
SP bank 210 sends this encrypted payment request;
Client bank 206 decrypts the payment request with its private key and checks it;
Both banks (206 and 210) respectively carry the debit and credit of the account of client 202 and SP 204.

Processing continues to 736, where processing ends.

It will be appreciated that the secure channel between actors and the encryption schemes ensure the confidentiality of exchanged data according to the protocol described above. The use of random numbers can provide for the freshness of messages, avoid the linkability leaks of information per comparison, and ensure data integrity. Authentication of entities can be realized through certificates, one for the SP and one for each bank without requiring that the trusted third party (e.g., IS 212) be one of banks. Thus, contrary to the SET protocol, the trusted third party is not one of the banks. The banks own certificates issued by the trusted third party. For example, SP 204's certificate can be provided by IS 212 or another trusted authority. The certificates allow for the signing, encrypting and decrypting of information and to prove the validity of the SP and banks

In some embodiments, the interbank system manages the bank certificates and authenticates the SP bank and the client's bank. Moreover, the IS can check information contained in the signed electronic voucher and give a validation of the voucher for the SP bank. The contract signed by the SP then allows the client to obtain his/her service with indicated conditions. Finally, validation of the client's bank identity by IS and verification of transaction information by the SP bank ensure the SP to be paid once the service provided. Moreover, these verifications by IS also allow to tax evasion and/or avoid money laundering by malicious SP and/or malicious SP bank.

The disclosed subject matter is more respectful of the users' (e.g., client's) privacy than the SET protocol and 3D-Secure protocol. The SP authentication by the client and then the SP banks can ensure the SP validity and the client does not provide personal order data as long as he/she is not certain to use a service. Moreover, the client's identity is never disclosed and the SP bank does not know the client. This authentication is realized by the client's bank. More precisely, in order to respect the client's privacy during the transfer of data to different banks, the order number, used in the process shown in FIG. 4 above, should not to contain SP information, such as the business number. Consequently, it should be random or unidentifiable. As an indication, in some embodiments in which the two banks would be the same, all requirements would be preserved except that the bank could know the SP and the client.

Secondly, the filtered contract, with the encrypted beneficiary's name and the random order number. In addition, the client's bank knows neither contents of the basket, nor the SP with whom his/her client deals. This new proposition also solves the other privacy problems of 3D-Secure protocol. The client's banking information is preserved against the SP. The encrypted voucher with IS public key allows the SP not to have knowledge of the client's bank.

Moreover, contrary to all the existing e-payment architecture, the client's banking information is never disclosed to the SP. Moreover, the client can be anonymous.

Finally, the voucher encrypted with IS public key prevents the client to know the SP's bank. Consequently, the protection of some SP personal information is also ensured by the disclosed protocol. This requirement can be important when the SP is a small organization and consequently, when the SP bank is the same bank as the manager's personal bank.

The most sensitive data of client and SP are protected. The client only provides the necessary, appropriate and relevant information (minimization and sensitivity principles). In addition, the fifth part performs at the end of the architecture. Thus, the privacy can be protected at the most without constraint of data disclosure. In some embodiment, once the SP has signed the contract, the client should click two times to accept it: once for the confirmation of his/her basket and once for the validation of the payment. Thus, the client has read two times the similar information. These two clicks can be used to ensure the client's. In some embodiments, these clicks can be replaced by a client's signature based on a certificate. In some embodiments, the certificate can be present in the client's identity card or his/her passport. Finally, the ownership of a certificate by the client is not necessary, contrary to SET protocol for instance.

The table below summarizes the analysis of the disclosed architecture compared to the existing 3D-Secure protocol.

| | 3D-Secure | Subject Matter |
|---|---|---|
| Properties | Protocol | Disclosed Herein |
| Confidentiality of | Yes | Yes |
| transactions | | |
| Integrity | Yes | Yes |
| Confidentiality of | No | Yes |
| client's identity for SP | | |
| Confidentiality of | No | Yes |
| client's identity for SP | | |
| bank | | |
| C's authentication | | Yes |
| SP authentication | No | Yes |
| Banks authentication | Yes | Yes |
| Unlinkability | Yes | Yes |
| Confidentiality of | No | Yes |
| Order information | | |
| Confidentiality | No | Yes |
| of banking information | | |
| C's anonymity | No | Yes |
| SP data minimization | No | Yes |
| Data | No | Yes |
| sovereignty | | |
| Data sensitivity | No | Yes |
| Ownership of | Yes | Yes |
| certificate not | | |
| necessary | | |

In some embodiments, Signature can be used. In such embodiments, Signature may be with or without data retrieval.

In some embodiments, client 202's certificate can be stored in and/or generated by an identity card or an IAS passport.

It will be appreciated that the initial contract proposal may be performed by SP 204 or by client 202, with corresponding changes to the exchange of messages and protocols.

In some embodiments, encryption by public key may be replaced by encryption by a symmetric key, which is added to the protocol message information, encrypted by the public key.

In some embodiments, a browser toolbar (similar, for example, to Google's Toolbar) may be added to the client Internet browser that allows through a button to activate an application (e.g., instead of a PlugIn) responsible for:
Building up the filtered information from the commercial proposal between the SP and the client;
Connecting to client bank, using the usual authentication mechanism of the home banking application;
Sending the voucher request;
Waiting for the voucher; and
Wrapping the voucher with the contract.

In such embodiments, client then signs the contract and sends it back with voucher to the SP.

It will be appreciated that the IS or the intermediate Certification Authority (CA) involved in one online e-payment transaction may be unique or in the same chain of certification or in different IS/CA systems.

It will also be appreciated that some embodiments can also be used to transfer money between two clients.

It will be appreciated that the modules, processes, systems, and sections described above can be implemented in hardware, hardware programmed by software, software instructions stored on a nontransitory computer readable medium or a combination of the above. An online privacy preserving e-payment architecture system, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or transponder device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the computer programming and postal address recognition arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for an online privacy preserving e-payment architecture system.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

Data Security of Some Embodiments

Firstly, the authentication protocols and secure channel between actors ensure the security principle. It is also reinforced by the possession of Client, SP and banks certificates. The banks own certificates issued by the IS. The SP certificate is provided by IS or an intermediate certification authority which are not known by the Client or its bank as related to the SP bank. The Client's certificate is provided by IS or an intermediate certification authority which are not known by the SP or its bank as related to the Client's bank. These documents allow to sign, encrypt and decrypt information and to prove the validity of the Client, SP and banks. Thus, contrary to the SET protocol, the trusted third part is not one of the banks

Then, the transferred data are always encrypted using asymmetric protocols through a secure channel. Consequently, the confidentiality and the integrity are always respected.

Moreover, the IS manages the bank certificates. Consequently, it checks information contained in the signed electronic voucher and gives a validation of voucher for the SP bank. Thus, validation of the client's bank identity by the IS and verification of transaction information by the SP bank assure the SP to be paid once the service provided.

Finally, the signed contract by the SP allows client to obtain his service with indicated conditions.

Principles of Privacy of Some Embodiments

Firstly, in some embodiments, the client's personal data and these intentions are heavily protected. Indeed, in some embodiments, the client can be configured so that it does not provides personal data to the SP even when the client is certain to use a service and pays for it.

Then, in some embodiments, our architecture is more respectful of the users' privacy than the SET protocol and 3D-Secure protocol. Thanks to filtered contract, in some embodiments, encrypted recipient name and random order number, the client's bank knows neither contents of the basket, nor the SP with whom his client is dealing with. Moreover, in some embodiments, the client's identity is not disclosed to the SP. Consequently, the SP bank does not know the customer.

In addition, in some embodiments, this new proposition solves the others privacy problems of 3D-Secure protocol. Indeed, in some embodiments, the client's personal information is preserved against the SP. In some embodiments, the encrypted voucher with private key of the IS allows the SP not to have knowledge of the client's bank.

Moreover, the client's banking information is not disclosed to the SP. Thus, the most sensitive data of customer are protected.

Thus, in some embodiments, the client only provides the necessary, appropriate and relevant information. In such embodiments, the minimization and sensitivity principle are ensured. In such embodiments, the sovereignty principle is also guaranteed thanks to the electronic signature for validation of the contract by the SP and the client.

Finally, in some embodiments, the voucher encrypted with the IS public key prevents the client to know the SP bank. Consequently, the protection of some SP personal information is also assured in such embodiments.

| | Disclosed | | |
|---|---|---|---|
| Properties | Subject Matter | 3D-Secure | SET |
| Minimization principle | ⋆⋆⋆ | ⋆ | |
| Sovereignty principle | ⋆⋆ | | |
| Sensibility principle | ⋆⋆⋆ | ⋆⋆ | |
| Security principle | X | X | X |
| Confidentiality | X | X | X |
| Integrity | X | X | X |
| Anonymity | X | | |
| Pseudonymity | X | | |
| Authentication | X | X | X |

The analysis of the discosed e-payment architecture

In other embodiments, Signature, when used, may be with or without data retrieval.

In other embodiments, the client certificate may be directly present in the client's identity card or his IAS passport.

In other embodiments, the initial contract proposal may be done by the SP or by the client, changing the cinematic and content of the exchanges and protocols.

In other embodiments, encryption by public key may be replaced by encryption by a symmetric key, which is added to the protocol message information, encrypted by the public key.

In some embodiments, A Google like bar may be added to the client Internet browser. It allows through a button to activate an application (instead of a macro) responsible for:
Building up the filtered information from the commercial proposal between the SP and the client;
Connecting to the client bank, using the usual authentication mechanism of the home banking application;
Sending the voucher request;
Waiting for the voucher;
Wrapping the voucher with the contract.

Then the client signs the contract and sends it back with the voucher to the SP.

In some embodiments, The IS or Intermediate Certification Authority involved in one online e-payment transaction may be unique or in the same chain of certification or in different IS systems.

Thus, has been shown an e-payment systems and method for online electronic payments in which data privacy is preserved.

What is claimed is:

1. A computer system providing privacy in online transactions, said computer system comprising:
a processor; and
a memory coupled to the processor, the memory having stored therein software instructions that, when executed by the processor, cause the processor to perform operations including:
receiving a purchase request from a client, the purchase request including banking information, the banking information being encrypted with a third party public key such that the system cannot decrypt the encrypted banking information;
transmitting the encrypted banking information to a bank system, wherein the banking information cannot be used to identify the identity of the client;
receiving an authorization message if the client's purchase request is authorized.

2. The system of claim 1,
wherein the banking information includes a voucher, the voucher including a purchase amount, a random order number, and client bank information,
wherein the voucher is generated and encrypted by a bank at which the client has an account, the account being identified by the client bank information, and the voucher being encrypted with the third party public key, and
wherein the system cannot decrypt the voucher to access the client bank information.

3. The system of claim 1,
wherein the transmitting the encrypted banking information to the bank system causes the bank system to transmit the encrypted banking information to a trusted third party to be decrypted using a third party private key.

4. The system of claim 2, wherein the banking information is pre-validated by the client's bank.

5. The system of claim 1, wherein the purchase request includes a symmetric session key and the symmetric session key is used to encrypt messages transmitted to the client.

6. The system of claim 1, wherein the operations further include providing a service to the client if the client's purchase is authorized.

7. A method for providing privacy in online transactions, the method comprising:
receiving, at a service provider system, a purchase request from a client, the purchase request including banking information, the banking information being encrypted with a third party public key such that the service provider system cannot decrypt the encrypted banking information;
transmitting the encrypted banking information to a bank system, wherein the banking information cannot be used to identify the identity of the client;
receiving an authorization message from the bank system if the client's purchase request is authorized.

8. The method of claim 7,
wherein the banking information includes a voucher, the voucher including a purchase amount, a random order number, and client bank information,
wherein the voucher is generated and encrypted by a bank at which the client has an account, the account being identified by the client bank information, and the voucher being encrypted with the third party public key, and
wherein the service provider system cannot decrypt the voucher to access the client bank information.

9. The method of claim 7,
wherein the transmitting the encrypted banking information to the bank system causes the bank system to transmit the encrypted banking information to a trusted third party to be decrypted using a third party private key.

10. The method of claim 8, wherein the banking information is pre-validated by the client's bank.

11. The method of claim 7, wherein the purchase request includes a symmetric session key and the symmetric session key is used to encrypt messages transmitted to the client.

12. The method of claim 7, wherein the operations further include providing a service to the client if the client's purchase is authorized.

13. A non-transitory computer readable medium having stored thereon software instructions that, when executed by a computer, cause the computer to perform operations comprising:
receiving a purchase request from a client, the purchase request including banking information, the banking information being encrypted with a third party public key such that the system cannot decrypt the encrypted banking information;
transmitting the encrypted banking information to a bank system, wherein the banking information cannot be used to identify the identity of the client;
receiving an authorization message if the client's purchase request is authorized.

14. The computer readable medium of claim 13,
wherein the banking information includes a voucher, the voucher including a purchase amount, a random order number, and client bank information,
wherein the voucher is generated and encrypted by a bank at which the client has an account, the account being identified by the client bank information, and the voucher being encrypted with the third party public key, and
wherein the system cannot decrypt the voucher to access the client bank information.

15. The computer readable medium of claim 13,
wherein the transmitting the encrypted banking information to the bank system causes the bank system to transmit the encrypted banking information to a trusted third party to be decrypted using a third party private key.

16. The computer readable medium of claim 14, wherein the banking information is pre-validated by the client's bank.

17. The computer readable medium of claim 13, wherein the purchase request includes a symmetric session key and the symmetric session key is used to encrypt messages transmitted to the client.

18. The computer readable medium of claim 13, wherein the operations further include providing a service to the client if the client's purchase is authorized.
